(19) United States
(12) Patent Application Publication
(10) Pub. No.: US 2015/0016087 A1
(43) Pub. Date: Jan. 15, 2015

(54) Circuit Board, Method For Manufacturing The Circuit Board, And Illumination Device Comprising The Circuit Board

(71) Applicant: OSRAM GMBH, München (DE)

(72) Inventors: ChengCheng Feng, Shenzhen Guangdong (CN); Xiaomian Chen, Shenzhen Guangdong (CN); Chuanpeng Zhong, Shenzhen Guangdong (CN); Hao Li, Shenzhen Guangdong (CN)

(21) Appl. No.: 14/377,755

(22) PCT Filed: Feb. 7, 2013
(86) PCT No.: PCT/EP2013/052454

§ 371 Date: Aug. 8, 2014

(30) Foreign Application Priority Data
Feb. 8, 2012 (CN) 201210027869.6

(51) Int. Cl. F21K 99/00

(52) U.S. Cl. CPC F21K 9/50; F21K 9/90; F21K 9/30; F21K 9/56
USPC 362/84; 362/297; 29/847

(57) ABSTRACT

A circuit board (1) for mounting at least one light source (10), comprising a substrate (2) and a plurality of printed electrical conductors (3) printed on the substrate (2), At least one printed electrical conductor (3) comprises a first region (4) for arranging the light sources (10). The circuit board (1) further comprises reflectors (5) which are disposed between the printed electrical conductors (3) adjacent to each other and cover other regions of the printed electrical conductors (3) than the first region (4), wherein the reflectors (5) are insulating reflectors. The circuit board is easy to manufacture, has relatively high reflective property, and can efficiently reflect the light emitted from the light source. Also disclosed are a method for manufacturing the circuit board, and an illumination device comprising the circuit board.

### RELATED APPLICATIONS

This application is a U.S. National Phase Application under 35 USC 371 of International Application PCT/EP2013/052454 filed Feb. 7, 2013.

This application claims the priority of Chinese application No. 201210027869.6 filed February 8, the entire content of which is hereby incorporated by reference.

### FIELD OF THE INVENTION

The present invention relates to a circuit board, a method for manufacturing the circuit board and an illumination device comprising the circuit board.

### BACKGROUND OF THE INVENTION

Nowadays, the package plate for COB LEDs usually consists of a base board, a first insulating layer, an electrical conductive layer such as copper or silver, and a second insulating layer from the bottom to the top. After an etching process, some parts of the second insulating layer are removed and the electrical conductive layer is exposed, so as to form a circuit arrangement.

In this way, the LEDs are surrounded by the insulating layer, and the reflectivity of the insulating layer will significantly affect the light output of COB light sources, especially COB LEDs. In theory, the higher the reflectivity of the insulating layer is, the higher the optical efficiency of the COB LEDs will be. However, in the prior art, the materials of the insulating layer are mainly white oil, which has a relatively low reflectivity of about 60-70%. As a result, it will absorb a part of light from the LED chips.

### SUMMARY OF THE INVENTION

In order to solve the above problem, one aspect of the present invention provides a circuit board for mounting at least one light source, which is easy to manufacture, has relatively high reflective property, and can efficiently reflect the light emitted from the light source.

An embodiment of the present invention provides a circuit board for mounting at least one light source, comprising a substrate and a plurality of printed electrical conductors printed on the substrate, characterized in that, at least one printed electrical conductor comprises a first region for arranging the light source, the circuit board further comprises reflectors which are disposed between the printed electrical conductors adjacent to each other and cover other regions of the printed electrical conductors than the first regions, wherein the reflectors are insulating reflectors.

A reflector with insulating property and high reflectivity is used to substitute an insulating layer which is usually used to cover the printed electrical conductors and the regions between the printed electrical conductors adjacent to each other, so as to enable the circuit board of the present invention to have reflective property while ensuring insulation between the printed electrical conductors. At least one light source is mounted in the predetermined first region, and some of the light emitted from the light source can be reflected by the reflectors in other regions than the first regions, which, thereby, can avoid light loss due to the light absorption by the circuit board.

According to a preferred design solution of the present invention, the reflectors are distributed Bragg reflectors. The distributed Bragg reflector (DBR) is comprised of two kinds of materials having different refractive indexes, and the two kinds of materials grow alternatively to form a structure having a plurality of layer pairs. The reflective property of the DBR is determined by the number of layers in the structure, the thickness of each layer, the refractive indexes of the two kinds of materials in the structure, and the absorption and scattering properties of each layer. The greater the gap between the refractive indexes of the two kinds of materials forming the DBR layer pair, the higher the reflectivity of the layer pair is.

According to a preferred design solution of the present invention, the reflectors cover, through electron beam evaporation process or magnetron sputtering process, regions between the printed electrical conductors adjacent to each other, and the other regions than the first regions. Thus, the reflectors can uniformly cover these regions, so as to ensure uniformity of the reflectors on the circuit board. Moreover, the processes are helpful to the control of the thickness and structure of the reflectors.

According to a preferred design solution of the present invention, the reflector comprises a first layer made from SiO₂ and a second layer made from TiO₂. The distributed Bragg reflectors can be divided into semiconductor DBRs and insulating DBRs. A typical insulating DBR layer is composed of SiO₂ and TiO₂, which ensures that the circuit board has reflective property while having the insulating property.

According to a preferred design solution of the present invention, a thickness D of the first layer or the second layer is calculated according to a formula D=λ/4n, where λ is a central wavelength of light emitted by the light source, and n is a refractive index of the first layer or the second layer. The central wavelength here is, for example, the dominant wavelength of blue light when the blue LED is used as a light source. The refractive index of SiO₂ is 1.47, and the refractive index of TiO₂ is 2.52. Thus, the numerical value of n is fixed, and an appropriate thickness D can be obtained by adjustment according to the wavelength of the light source.

According to a preferred design solution of the present invention, the reflector is a composite layered structure formed by alternatively disposing the first layer and the second layer. That is, the first layer and the second layer can grow in the manner of ABAB.

According to a preferred design solution of the present invention, the first layer and the second layer are alternatively disposed 3-7 times to form the reflector, wherein the reflector comprises 3-7 first layers and 3-7 second layers.

Preferably, the first region is arranged in a central region of respective printed electrical conductor. In this way, the reflectors disposed to surround the first region perform overall reflection to the light emitted from the light source mounted in the first region.

In addition, another aspect of the present invention relates to a method for manufacturing the above circuit board for mounting at least one light source, characterized by comprising the steps of:

a) providing a substrate printed with a plurality of printed electrical conductors;

b) covering the printed electrical conductors and regions between the printed electrical conductors adjacent to each other with insulating reflectors; and

c) removing part of the reflectors which are on the printed electrical conductors to form a first region for mounting the light source.

On the printed electrical conductors, the first region for the light source is reserved and other regions than the first region and the regions between the printed electrical conductors adjacent to each other are covered with the reflectors having high reflectivity.

Another aspect of the present invention relates to an illumination device, comprising at least one LED chip, characterized by further comprising the above circuit board, wherein the LED chip, as the light source, is mounted on the first region of the printed electrical conductor. In this way, the light source can be fixed on the first region, and when the light source works, the reflectors disposed to surround the first region favorably reflect the light emitted from the light source.

According to a preferred design solution of the present invention, the LED chip and the circuit board are integrally packaged through a COB process. The circuit board manufactured by the COB process has low cost, and has good sealing performance and high reliability.

According to a preferred design solution of the present invention, the light source is a blue LED, and the illumination device further comprises a remote phosphor cover stimulated to produce yellow light. In this way, the illumination device can emit mixed white light, and the optical efficiency of the illumination device can be improved.

The circuit board proposed according to the present invention is easy to manufacture, has relatively high reflective property, and can efficiently reflect the light emitted from the light source.

### BRIEF DESCRIPTION OF THE DRAWINGS

The accompanying drawings constitute a part of the present Description and are used to provide further understanding of the present invention. Such accompanying drawings illustrate embodiments of the present invention. In the accompanying drawings, the same components are represented by the same reference numbers. In the drawings,

FIG. 1 is a sectional view of a circuit board according to the first embodiment of the present invention;

FIG. 2 is a flow chart showing the manufacturing of the circuit board in FIG. 1; and

FIG. 3 shows an illumination device according to the second embodiment of the present invention.

### DETAILED DESCRIPTION OF THE DRAWINGS

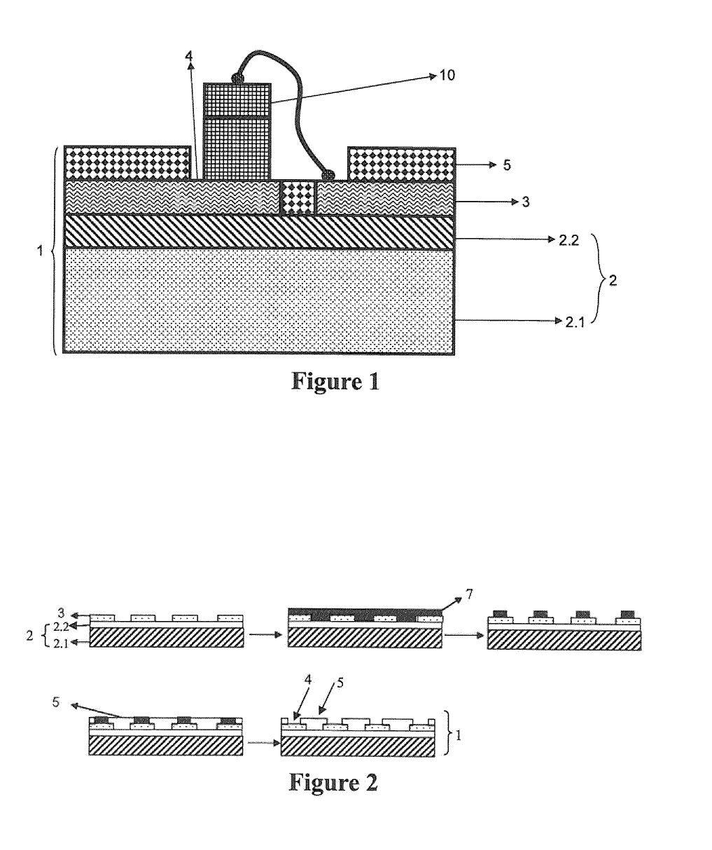

FIG. 1 is a sectional view of a circuit board according to the first embodiment of the present invention. The circuit board 1 comprises a substrate 2 and a plurality of printed electrical conductors 3 printed on the substrate. The substrate 2 comprises a base board 2.1 manufactured by the materials such as aluminum, copper or ceramic, and a first insulating layer 2.2 covering the base board 2.1. at least one first regions 4 for mounting a sources 10 is reserved on some of the printed electrical conductor 3. In order to enable the circuit board 1 to have superior reflective property, the regions between the printed electrical conductors 3 adjacent to each other and the other regions than the first region 4 are in particular covered with the reflectors 5 having high reflectivity. The light sources 10 are, for example, LED chips, especially blue LED. It is unnecessary to reserve mounting regions for the light source 10 on the other printed electrical conductors 3, and other electronic devices can be mounted on these printed electrical conductors 3.

According to a preferred embodiment of the present invention, the reflectors 5 are distributed Bragg reflectors. The reflectors 5 uniformly cover, through electron beam evaporation process or magnetron sputtering process or a similar process, regions between the printed electrical conductors 3 adjacent to each other, and the other regions than the first region 4, so as to ensure equality of reflectivity on these regions. The reflector 5 comprises a first layer made from SiO₂ and a second layer made from TiO₂. Such insulating reflector 5 substitutes the second insulating layer on the conventional circuit board to serve the function of insulation, and has more favorable reflective property.

According to the properties of the light emitted from the light source 10, the first layer and the second layer having different thicknesses can be selected. The thickness D of the first layer or the second layer is calculated according to a formula D=λ/4n, where λ is a central wavelength of light, and n is a refractive index of the first layer or the second layer. For example, when the first layer is SiO₂, n is 1.47; and when the second layer is TiO₂, n is 2.52. Thus, with respect to the first layer and the second layer having fixed materials, it is feasible to form the reflector 5 by alternatively disposing the first layer and the second layer in the manner of ARAB combinations, the reflector 5 having a composite layered structure. In the present embodiment, the first layer and the second layer are alternatively disposed 3-7 times, that is, the reflector 5 comprises 3-7 first layers and 3-7 second layers. Thus, the so-formed reflector 5 has an ideal reflectivity of, for example, 99%.

In addition, electrical connection between the light source 10 and the printed electrical conductor 3 is schematically shown with black line in FIG. 1.

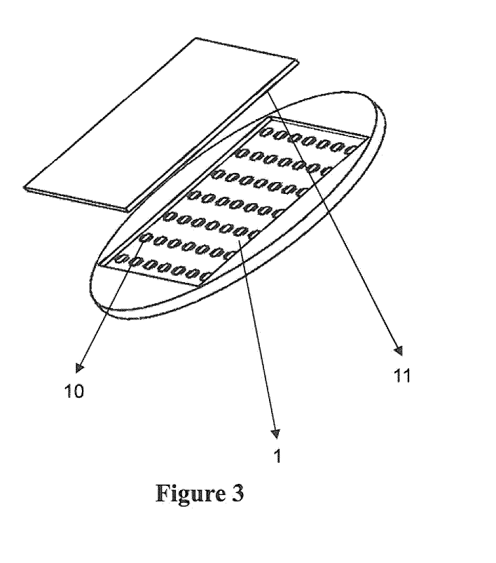

FIG. 2 is a flow chart showing the manufacturing of the circuit board in FIG. 1. The circuit board according to the present invention is pre-processed in the conventional manner for manufacturing a printed circuit board, a substrate 2 with a plurality of printed electrical conductors 3 printed on a surface thereof is provided firstly, and then the printed electrical conductors 3 and regions between the printed electrical conductors 3 adjacent to each other are coated with photoresist layers 7. With the exception of the first regions 4 on some of the printed electrical conductors 3 which are reserved for light sources 10 (see FIG. 1), the photoresist layers 7 covering the other regions are removed through the UV radiation. In the following procedure, the reflectors 5 formed by alternatively disposing SiO₂ and TiO₂ cover the regions which are not covered by the photoresist layers 7. Finally, the photoresist layers 7 are removed from the first regions 4 to form a space for mounting the light source 10.

FIG. 3 shows an illumination device according to the second embodiment of the present invention. In the present embodiment, the LED chip, which serves as the light source 10, and the circuit board 1 are integrally packaged preferably through a COB process, wherein the LED chip is a blue LED. The illumination device further comprises a remote phosphor cover 11. Thus, some of the blue light emitted from the light source 10 is stimulated by the remote phosphor cover 11 to produce yellow light, and the other blue light is reflected by the circuit board 1 having reflective property such that the blue light is mixed with the yellow light to produce white light. In the illumination device according to the present invention, the light loss due to the light absorption by the circuit board 1 is significantly reduced.

The above is merely preferred embodiments of the present invention but not to limit the present invention. For the person skilled in the art, the present invention may have various alterations and changes. Any alterations, equivalent substitutions, improvements, within the spirit and principle of the present invention, should be covered in the protection scope of the present invention.

1. A circuit board for mounting at least one light source, comprising a substrate and a plurality of printed electrical conductors printed on the substrate, wherein, at least one printed electrical conductor comprises a first region for arranging the light source, the circuit board further comprises reflectors which are disposed between the printed electrical conductors adjacent to each other and cover other regions of the printed electrical conductors than the first region, wherein the reflectors are insulating reflectors.

2. The circuit board according to claim 1, wherein the reflectors are distributed Bragg reflectors.

3. The circuit board according to claim 2, wherein the reflectors cover, through electron beam evaporation process or magnetron sputtering process, regions between the printed electrical conductors adjacent to each other, and the other regions than the first region.

4. The circuit board according to claim 1, wherein the reflector comprises a first layer made from SiO2 and a second layer made from TiO2.

5. The circuit board according to claim 4, wherein a thickness D of the first layer or the second layer is calculated according to a formula D=λ/4n, where λ is a central wavelength of light emitted by the light source, and n is a refractive index of the first layer or the second layer.

6. The circuit board according to claim 4, wherein the reflector is a composite layered structure formed by alternatively disposing the first layer and the second layer.

7. The circuit board according to claim 6, wherein the first layer and the second layer are alternatively disposed 3-7 times to form the reflector, wherein the reflector comprises 3-7 first layers and 3-7 second layers.

8. The circuit board according to claim 1, wherein the first region is arranged in a central region of respective printed electrical conductor.

9. A method for manufacturing a circuit board for mounting at least one light source according to claim 1, comprising the steps of:
a) providing a substrate printed with a plurality of printed electrical conductors;
b) covering the printed electrical conductors and regions between the printed electrical conductors adjacent to each other with insulating reflectors; and
c) removing part of the reflectors which are on the printed electrical conductors to form a first region for mounting the light source.

10. An illumination device, comprising at least one LED chip, further comprising a circuit board according to claim 1, wherein the LED chip, as the light source, is mounted on the first region of the circuit board.

11. The illumination device according to claim 10, wherein the LED chip and the circuit board are integrally packaged through a COB process.

12. The illumination device according to claim 10, wherein the light source is a blue LED chip, and the illumination device further comprises a remote phosphor cover stimulated to produce yellow light.
